(19) United States
(12) Patent Application Publication
(10) Pub. No.: US 2008/0170044 A1
(43) Pub. Date: Jul. 17, 2008

(54) Image Printing Apparatus and Method for Processing an Image

(75) Inventor: Makoto KANADA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/013,764

(22) Filed: Jan. 14, 2008

(30) Foreign Application Priority Data
Jan. 16, 2007 (JP) 2007-006494

(51) Int. Cl. G06F 3/041

(52) U.S. Cl. 345/173

(57) ABSTRACT

An image printing apparatus is provided. The image printing apparatus includes a touch screen panel, having a display screen to display an image, configured to acquire a locating instruction from a user for specifying a location on the display screen; and an image processing unit configured to perform predetermined image processing on a facial area containing a human face within a target image, the target image being targeted for printing by the image printing apparatus, wherein the image processing unit includes: a target image display control unit configured to display the target image on the display screen; and a processing area identifying unit configured to identify the facial area within the target image subject to the predetermined image processing based on the locating instruction, the locating instruction being acquired by the touch screen panel and specifying a location within an area on the display screen where the facial area is present.

### CROSS-REFERENCE TO RELATED APPLICATIONS

The present application claims the priority based on Japanese Patent Application No. 2007-6494 filed on Jan. 16, 2007, the disclosure of which is hereby incorporated herein by reference in its entirety.

### BACKGROUND OF THE INVENTION

1. Field of the Invention

The present invention relates to a technique for determining an area to which image processing is applied in an image printing apparatus.

2. Description of the Related Art

In an image printing apparatus such as a printer or a scanner-printer-copier (also called a “multi-function printer” or “MFP”), a processed image is printed by applying image processing in advance to the image to be printed. The image processing techniques performed by the image printing apparatus include those desirable for application only to localized areas of the image such as a facial area, exemplified by the red-eye reduction processing that modifies the color of human eyes. To perform such image processing, an area subject to the image processing is detected by analyzing the image, and the image processing is applied to the detected area subject to the image processing.

However, when areas subject to the image processing are detected by analyzing the image, even an area not desirable for processing may be detected as that subject to processing, or an area desirable for processing may not be detected as that subject to processing. There is a risk of not getting a desirable image if the detection result is not desirable, as in these cases.

### SUMMARY OF THE INVENTION

An object of the present invention is to improve image processing results in an image printing apparatus.

According to an aspect of the present invention, an image printing apparatus is provided. The image printing apparatus includes a touch screen panel, having a display screen to display an image, configured to acquire a locating instruction from a user for specifying a location on the display screen; and an image processing unit configured to perform predetermined image processing on a facial area containing a human face within a target image, the target image being targeted for printing by the image printing apparatus, wherein the image processing unit includes: a target image display control unit configured to display the target image on the display screen; and a processing area identifying unit configured to identify the facial area within the target image subject to-the predetermined image processing based on the locating instruction, the locating instruction being acquired by the touch screen panel and specifying a location within an area on the display screen where the facial area is present.

With this configuration, the user is able to specify a facial area within the target image subject to predetermined image processing by specifying a location within the target image displayed on the display screen of the touch screen panel. As a result, identification of the facial area subject to image processing may be performed more accurately, and the user may obtain improved image processing result.

The present invention may be implemented in various embodiments. For example, it can be implemented as an image printing apparatus and a method for image processing therein; a control device and a control method of the image printing apparatus; a computer program that realizes the functions of those devices and methods; a recording medium having such a computer program recorded thereon; and a data signal embedded in carrier waves including such a computer program.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a perspective view showing a multi-function printer 10 as an embodiment.

FIG. 2A is a block diagram showing an internal configuration of the multi-function printer 10.

FIG. 2B illustrates an example of the operation panel 500.

FIG. 3 is a flowchart showing an image printing routine for printing an image.

FIG. 4A illustrates a target image selection menu MN1 displayed on the display screen 512.

FIG. 4B is an illustration showing the user providing an instruction for selecting a target image to the multi-function printer 10.

FIG. 4C is an illustration showing the user specifying a printing method.

FIG. 5 is a flowchart showing a face modification routine executed in Step S160.

FIG. 6A illustrates a detection execution screen MN3 displayed on the display screen 512 of the touch screen panel 510 during the execution of Step S210.

FIG. 6B illustrates a detection result display screen MN4 displayed on the display screen 512 in Step S220.

FIG. 6C illustrates a facial area selection screen MN5 displayed on the display screen 512 in Step S250.

FIG. 7A is an illustration showing a facial area being selected by the user.

FIG. 7B illustrates a parameter setup screen MN6 for setting up a parameter of the face modification processing.

FIG. 7C illustrates a detection result display screen MN4a showing the facial area detection result after execution of the face modification processing.

FIG. 8 is a flowchart showing a face modification routine in the second embodiment.

FIG. 9A illustrates a facial area addition screen MN7 displayed on the display screen 512 in Step S212.

FIG. 9B illustrates a stroke obtaining screen MN8 displayed on the display screen 512 for obtaining information on strokes.

FIG. 9C illustrates a facial area addition screen MN7a displayed after the facial area is detected within the line TSF drawn as in FIG. 9B.

### DESCRIPTION OF THE PREFERRED EMBODIMENT

Embodiments of the present invention will be described below in the following order.
A. First Embodiment:
B. Second Embodiment:
C. Variations:

### A. First Embodiment

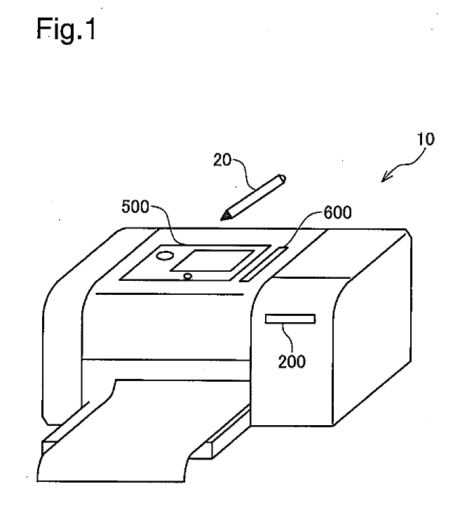

FIG. 1 is a perspective view showing a multi-function printer 10 as an embodiment of the present invention. The multi-function printer 10 functions as a printer and a scanner and is able to scan or print an image stand-alone mode without being connected to any external computer. The multi-function printer 10 has a memory card slot 200, an operation panel 500, and a stylus holder 600 for storing a stylus 20. The stylus holder 600 is mounted adjacent to the operation panel 500.

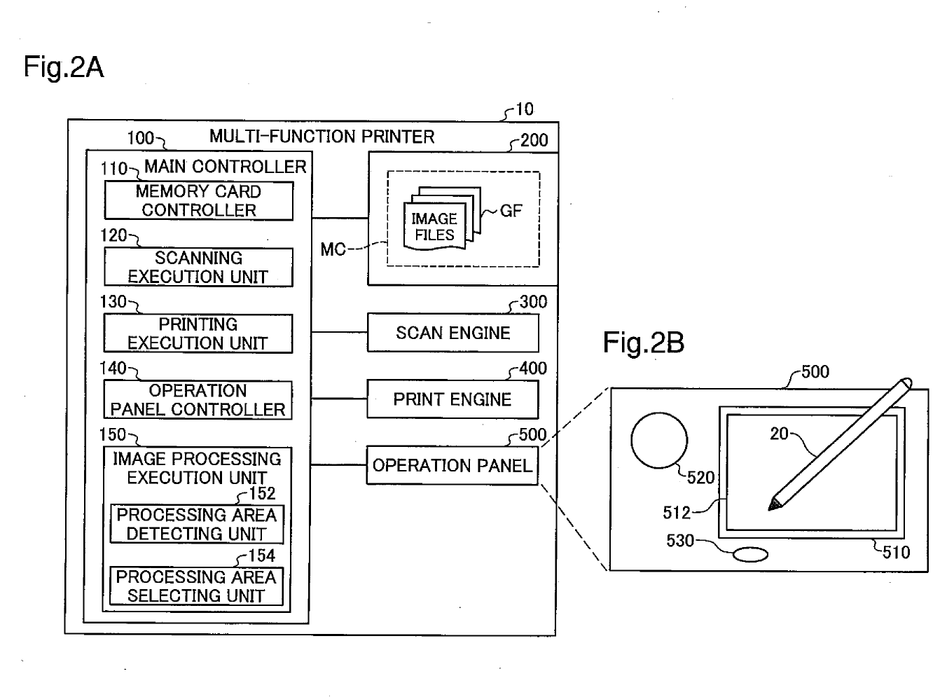

FIG. 2A is a block diagram showing an internal configuration of the multi-function printer 10. The multi-function printer 10 includes a main controller 100, the memory card slot 200, a scan engine 300, a print engine 400, and the operation panel 500.

The main controller 100 has a memory card controller 110, a scanning execution unit 120, a printing execution unit 130, an operation panel controller 140, and an image processing execution unit 150. The main controller 100 is configured as a computer equipped with a central processing unit (CPU) and the memory, which are not shown in the figure. The function of each component included in the main controller 100 is performed by the CPU executing the program stored on the memory. The image processing execution unit 150 (hereinafter, also termed simply as “image processor”) performs predetermined processing on an image. The image processor 150 includes a processing area detecting unit 152 and a processing area selecting unit 154. The image processing at the image processing execution unit 150 will be explained later.

The memory card slot 200 is a mechanism that receives a memory card MC. The memory card controller 110 stores a file into the memory card MC inserted in the memory card slot 200, or reads out the file stored in the memory card MC. The memory card controller 110 may only have a function of reading out the file stored in the memory card MC, as well. In the example of FIG. 2A, a plurality of image files GF are stored in the memory card MC which is inserted in the memory card slot 200.

The scan engine 300 is a mechanism that scans an original positioned on a scanning platen (not shown in the figure) and generates scan data representing the image formed on the original. The scan data generated by the scan engine 300 is supplied to the scanning execution unit 120. The scanning execution unit 120 generates image data in a predetermined format from the scan data supplied from the scan engine 300. It is also possible to configure the scan engine 300 to generate the image data instead of the scanning execution unit 120.

The print engine 400 is a printing mechanism that executes printing in response to given printing data. The printing data supplied to the print engine 400 is generated by the process wherein the printing execution unit 130 extracts image data from the image file GF in the memory card MC via the memory card controller 110 and performs color conversion and halftoning on the extracted image data. The printing data can also be generated by image data obtained from the scanning execution unit 120; image data supplied from a digital still camera connected via a USB connector, which is not shown in the figure; or received data supplied from an external device connected via the USB connector to the multi-function printer 10. It is also possible to configure the print engine 400 to carry out the color conversion and halftoning instead of the printing execution unit 130.

The operation panel 500 is a man-machine interface built in the multi-function printer 10. FIG. 2B illustrates an example of the operation panel 500. The operation panel 500 includes a touch screen panel 510, a power button 520 for turning on and off the power of the multi-function printer 10, and a shift button 530.

The touch screen panel 510 has a display screen 512. The touch screen panel 510 displays an image on the display screen 512 based on the image data supplied from the operation panel controller 140. The touch screen panel 510 also detects touching status of the stylus 20, which is provided with the multi-function printer 10, to the display screen 512. More specifically, the touch screen panel 510 detects where the touch location of the stylus 20 is situated within the display screen 512. The touch screen panel 510 accumulates time-series information on detected touch locations, and supplies the accumulated results to the operation panel controller 140 as touching status information. The shift button 530 is a button for changing interpretation of user's instruction provided to the multi-function printer 10 with the stylus 20.

The multi-function printer 10 obtains an instruction provided by the user based on the touching status information supplied from the touch screen panel 510 via the operation panel controller 140. More specifically, each component of the main controller 100 generates menu image data that represents menu prompting the user for an instruction, and supplies the generated menu image data to the touch screen panel 510 via the operation panel controller 140. The touch screen panel 510 displays the menu on the display screen 512 based on the menu image data supplied thereto. Next, each component of the main controller 100 obtains the touching status information from the touch screen panel 510 via the operation panel controller 140. The component determines whether the stylus 20 touches to a particular area on the menu displayed on the display screen 512, based on the obtained touching status information. If the stylus 20 contacts to the particular area, a user's instruction corresponding to the contacted area is obtained. Hereinafter, the user's act of touching a particular area of the menu displayed on the display screen 512 with the stylus 20 will be expressed as the user “operating” the particular area.

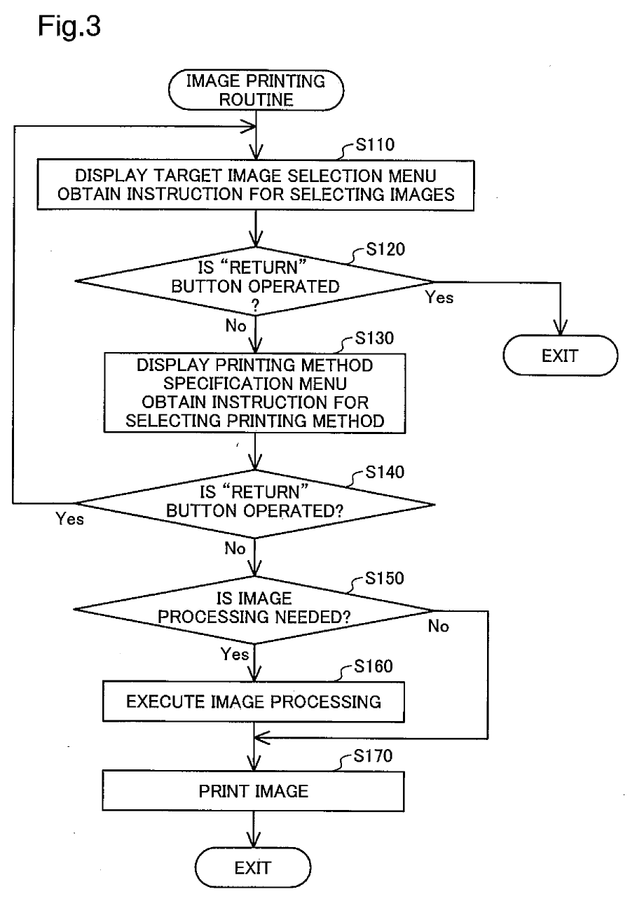

FIG. 3 is a flowchart showing an image printing routine for printing an image. This image printing routine is executed in response to a user's instruction for printing provided to the multi-function printer 10 with the stylus 20.

In Step S110, the printing execution unit 130 (FIG. 2) displays a menu for selecting images to be printed (target image selection menu) on the display screen 512 of the touch screen panel 510 (FIG. 2). Then, the printing execution unit 130 obtains an instruction for selecting a target image given by the user with the stylus 20.

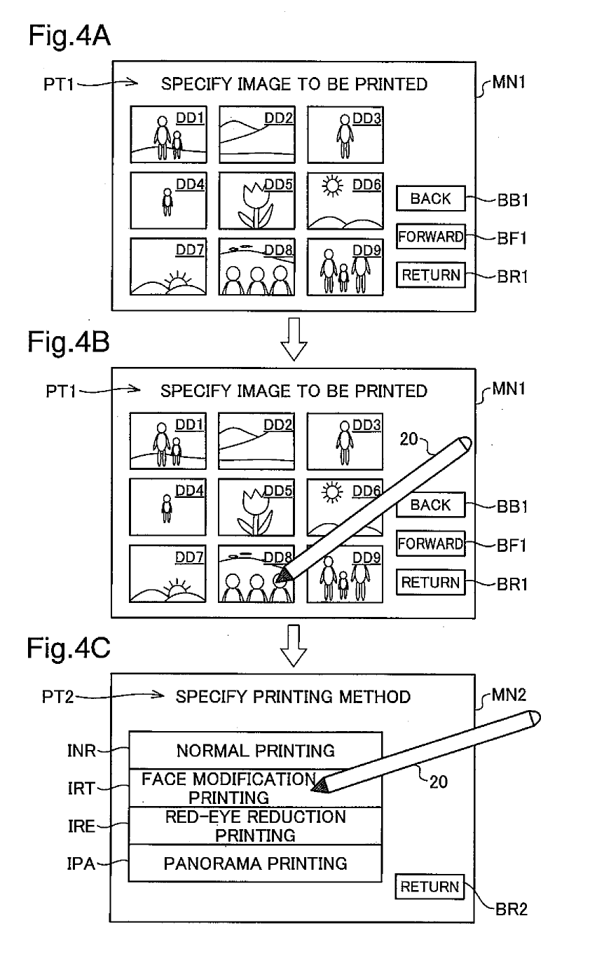

FIG. 4A illustrates a target image selection menu MN1 displayed on the display screen 512 (FIG. 2) in Step S110. In the target image selection menu MN1, a prompt message PT1 that prompts a selection of images to be printed, a “BACK” button BB1, a “FORWARD” button BF1, a “RETURN” button BR1 and nine images DD1 through DD9 are displayed.

The nine images DD1˜DD9 displayed in the target image selection menu MN1 are those of nine image files among a plurality of image files GF stored in the memory card MC (FIG. 2). When the user uses the stylus 20 to operate the “BACK” button BB1 or “FORWARD” button BF1, these nine images DD1˜DD9 are modified in the order sorted in the image files GF.

FIG. 4B is an illustration showing the user providing an instruction for selecting a target image to the multi-function printer 10 (FIG. 2). In the example of FIG. 4B, the user touches an area with the stylus 20 where the image DD8 in the target image selection menu MN1 is displayed. Thus, the image DD8 displayed in the target image selection menu MN1 is selected as a target image due to user's operation of the image DD8.

In Step S120 of FIG. 3, the printing execution unit 130 determines whether the “RETURN” button BR1 in the target image selection menu MN1 is operated. If the “RETURN” button BR1 is operated, the image printing routine of FIG. 3 terminates. On the contrary, if the “RETURN button BR1 is not operated, that is, one of the images DD1˜DD9 is selected, the process advances to Step S130. In the example of FIG. 4B, since the user operates the image DD8, Step S130 is executed.

In Step S130, the printing execution unit 130 displays a menu for specifying a printing method (printing method specification menu). Then, an instruction by the user using the stylus 20 for selecting a printing method is obtained.

FIG. 4C is an illustration showing the user specifying a printing method. As shown in FIG. 4C, a printing method specification menu MN2 contains a prompt message PT2 that prompts the user to specify a printing method, a “RETURN” button BR2, and four selection items INR, IRT, IRE and IPA of printing methods. In the example of FIG. 4C, the user operates the area where the selecting item “FACE MODIFICATION PRINTING” IRT is displayed.

In Step S140 of FIG. 3, the printing execution unit 130 determines whether the “RETURN” button BR2 of the printing method specification menu MN2 is operated. If the “RETURN” button is operated, the process goes back to Step S110 for selecting a target image. Meanwhile, if the “RETURN” button BR2 is not operated, that is, one of the selecting items INR, IRT, IRE or OPA is selected, the process advances to Step S150. In the example of FIG. 4C, since the user operates the selecting item “FACE MODIFICATION PRINTING” IRT, Step S150 is executed.

In Step S150, the printing execution unit 130 determines whether the printing method selected in Step S130 requires image processing. If the selected printing method does not require image processing, that is, the selecting item “NORMAL PRINTING” INR is operated, the process advances to Step S170. Then, in Step S170, the printing execution unit 130 prints out a target image on which image processing is not performed. On the contrary, if the selected printing method requires image processing, the process advances to Step S160, and image processing is executed corresponding to the selected printing method. Thus, in Step S170, the printing execution unit 130 prints out a target image on which image processing is performed.

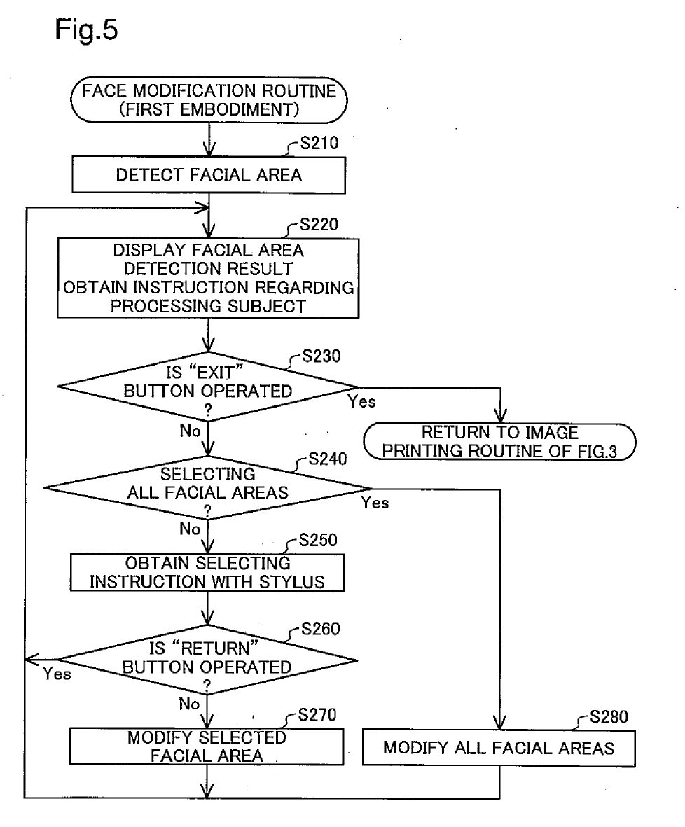

In the example of FIG. 4C, the user specifies the selected item “FACE MODIFICATION PRINTING” IRT in the printing method specification menu MN2. As a result, face modification processing is performed on the image DD8 in Step S160, and the image on which the face modification processing is performed is printed in Step S170. FIG. 5 is a flowchart showing a face modification routine executed in Step S160 of FIG. 3 as shown in the example of FIG. 4C.

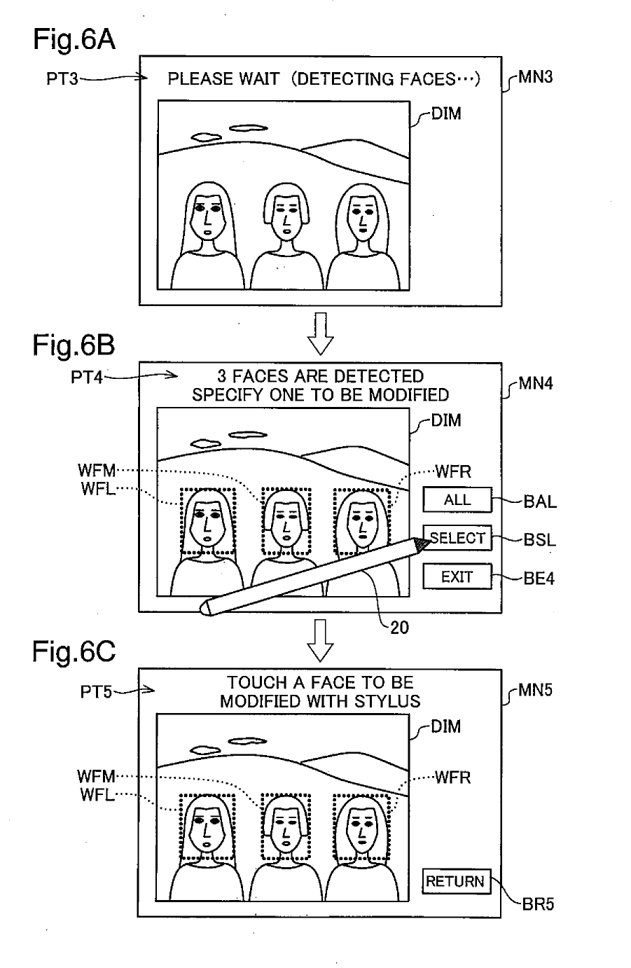

In Step S210, the processing area detecting unit 152 of the image processing execution unit 150 (FIG. 2) detects a facial area in the target image, which is subject to the face modification processing, by analyzing the target image. FIG. 6A illustrates a detection execution screen MN3 displayed on the display screen 512 of the touch screen panel 510 during the execution of Step S210. The detection execution screen MN3 displays a message PT3 notifying the user that the facial area detection is in progress, as well as a target image DIM subject to the face modification processing.

In Step S220 of FIG. 5, the processing area selecting unit 154 of the image processing execution unit 150 (FIG. 2) displays the facial areas detection result on the target image. Then, an instruction by the user regarding the facial areas subject to the modification is obtained. More specifically, either an instruction to perform face modification processing on all of the detected facial areas, or an instruction to perform the face modification processing on a particular facial area among the facial areas, is obtained.

FIG. 6B illustrates a detection result display screen MN4 displayed on the display screen 512 in Step S220. In the detection result display screen MN4, three facial frames WFL, WFM and WFR indicating detected facial areas are superimposed on target image DIM. The detection result display screen MN4 also shows a message PT4 that notifies the number of the detected facial areas to the user and prompts the user to specify target of modification, an “ALL” button BAL that specifies performance of the face modification processing on all the detected facial areas, a “SELECT” button BSL that specifies performance of the face modification processing on particular facial areas, and an “EXIT” button BE4.

In Step S230, the processing area selecting unit 154 determines whether the “EXIT” button BE4 in the detection result display screen MN4 (FIG. 6B) is operated. If the “EXIT” button BE4 is operated, the process returns to the image printing routine shown in FIG. 3. On the contrary, if the “EXIT” button BE4 is not operated, the process advances to Step S240. In the example of FIG. 6B, since the user operates the “SELECT” button BSL, the process advances to Step S240.

In Step S240, the processing area selecting unit 154 determines whether the instruction obtained in Step S220 is the one for performing the face modification processing on all facial areas detected in Step S210. If the user's instruction is for performing the face modification processing on all facial areas, the process goes to Step S280. On the other hand, if the user's instruction is for performing the face modification processing on a particular facial area, the process advances to Step S250. In the example of FIG. 6B, the user selects the “SELECT” button BSL that specifies performance of the face modification processing on a particular facial area. As a result, it is determined that the user's instruction is the one for performing the face modification processing on a particular facial area, and the process advances to Step S250.

In Step S250, the processing area selecting unit 154 obtains user's instruction selecting a facial area subject to the face modification processing among the facial areas detected in Step S210. FIG. 6C illustrates a facial area selection screen MN5 displayed on the display screen 512 in Step S250. The facial area selection screen MN5 shows a target image DIM, facial frames WFL, WFM and WFR, a “RETURN” button BR5, and a prompt message PT5 that prompts the user to select a facial area. As shown in FIG. 6C, since each of the facial frames WFL, WFM and WFR is an image for locating the facial areas in the target image, each of the facial frames may be called as “facial area locating image.” Also, the processing area selecting unit 154 may be called as “detection result display control unit” that displays the target image DIM in overlay with facial frames WFL, WFM and WFR, which are facial area locating images.

In Step S260 of FIG. 5, the processing area selecting unit 154 determines whether the “RETURN” button BR5 in the facial area selection screen MN5 is operated. If the “RETURN” button BR5 is operated, the process goes back to Step S220, and an instruction regarding subject of the modification is obtained. On the contrary, if the “RETURN” button BR5 is not operated, that is, one of the facial frames WFL, WFM or WFR is operated, the process advances to Step S270. Then, the face modification process is performed on the facial areas selected in Step S270 before the process goes back to Step S220.

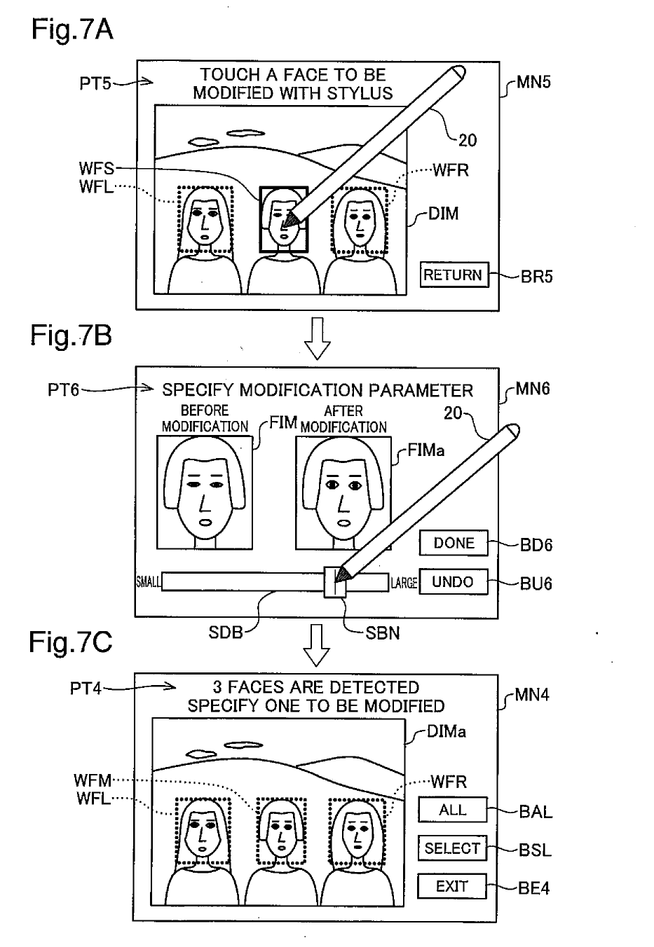

FIG. 7A through 7C are illustrations showing that a facial area is selected by the user, and the modification processing is performed on the selected facial area. The facial area selection screen MN5 in FIG. 7A differs from the facial area selection screen MN5 of FIG. 6C in that the central facial area is selected with the stylus 20, and the line style of the facial frame WFS of the selected facial area is changed to solid line, which indicates that the area is selected, from dotted line. Other points are the same with the facial area selection screen MN5 of FIG. 6C. As evident in FIG. 7A, the facial area subject to the face modification processing may be identified by the location where the tip of the stylus 20 contacts to the screen, that is, by the location on the target image DIM specified by the user with the stylus 20.

Once a facial area is selected for the modification processing, the image processing execution unit 150 (FIG. 2) displays a parameter setup screen MN6 for setting up a parameter of the face modification processing, as shown in FIG. 7B. The parameter setup screen MN6 shows a prompt message PT6 that prompts the user to set up a parameter, a “DONE” button BD6, an “UNDO” button BU6, and a slide bar for changing the parameter SDB. The parameter setup screen MN6 also shows a pre-modification image FIM prior to the modification processing being performed on the selected facial area WFS, and a post-modification image FIMa subsequent to the modification processing.

When the user drags a slide button SBN mounted in a slide bar SDB to the right direction using the stylus 20, the amount of eye enlargement gets larger as the slide button SBM moves. Thus, once the user operates the “DONE” button BD6 after setting up the modification parameter, the face modification processing is performed on the target image DIM (FIG. 7A) according to the set modification parameter. When the user operates the “UNDO” button BU6, the modification parameter is reset to the initial value.

FIG. 7C illustrates a detection result display screen MN4a showing the facial area detection result displayed on the display screen 512 of the touch screen panel 510 (FIG. 2) in Step S220 after execution of the face modification processing in Step S270 of FIG. 5. The detection result display screen MN4a shown in FIG. 7C differs from the detection result display screen MN4 shown in FIG. 6B in that the target image DIM is changed to the one after the face modification processing DIMa. Other points are the same as the detection result display screen MN4 shown in FIG. 6B.

In Step S240 of FIG. 5, if it is determined that the user's instruction obtained in Step S220 indicates that the face modification processing is to be performed on all facial areas, the face modification processing is performed on all facial areas. In this case, a modification parameter is set up for each facial area as shown in FIG. 7B, and the face modification processing is performed according to each of the set modification parameters. It is also available to set one same modification parameter for all facial areas. In this case, all facial areas are modified according to a preset default modification parameter.

Thus, in the first embodiment, the user is able to select a facial area subject to the face modification processing among facial areas within the target image DIM by touching the target image DIM, which is displayed on the display screen 512 of the touch screen panel 510, with the stylus 20. This allows the user to select a facial area subject to the face modification processing while viewing the target image DIM, so that the subject of the face modification processing can be selected more easily.

### B. Second Embodiment

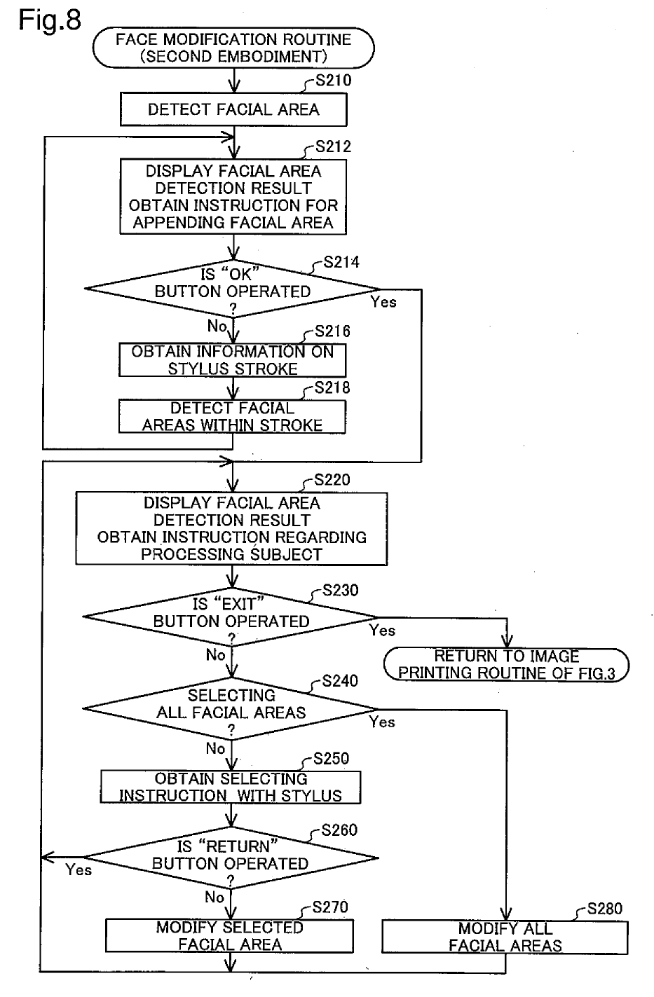

FIG. 8 is a flowchart showing a face modification routine in the second embodiment. The face modification routine of the second embodiment differs from that of the first embodiment in terms that four steps from Step S212 to Step S218 are added between Step S210 and Step S220. Other points are the same as the face modification routine in the first embodiment.

In Step S212, the processing area detecting unit 152 of the image processing execution unit 150 (FIG. 2) displays the facial area detection result detected in Step S210. Then, an instruction by the user as to whether to add a facial area is obtained.

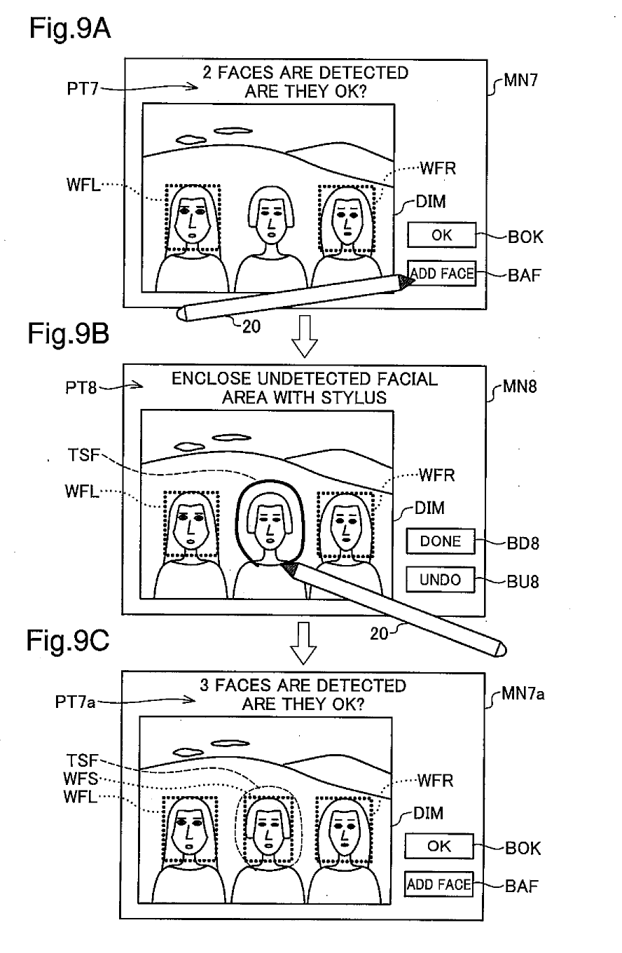

FIG. 9A illustrates a facial area addition screen MN7 displayed on the display screen 512 in Step S212. The facial area addition screen MN7 displays facial frames WFL and WFR representing two detected facial areas in overlay with the target image DIM. The facial area addition screen MN7 also displays a message PT7 that notifies the number of detected facial areas to the user and prompts the user to evaluate the facial area detection result; an “OK” button BOK indicating that the result is good; and an “ADD FACE” button BAF that indicates an addition to the facial area is required. In the example of FIG. 9A, the face of the person at the center among the target images DIM is not detected. So, the user operates the “ADD FACE” button BAF.

In Step S214 of FIG. 8, the processing area detecting unit 152 determines whether the “OK” button BOK is operated. If the “OK” button BOK is operated, the process goes to Step S220. On the contrary, if the “OK” button BOK is not operated, that is, the “ADD FACE” button BAF is operated, the process advances to Step S216. In the example of FIG. 9A, the user operates the “ADD FACE” button BAF with the stylus 20. As a result, it is determined that the “OK” button BOK is not operated in Step S216, and the process advances to Step S216.

In Step S216 of FIG. 8, the processing area detecting unit 152 obtains information on the location of undetected facial areas, so that the processing area detecting unit 152 obtains a graphic image (stroke) drawn by the user on the display screen 512 with the stylus 20.

FIG. 9B illustrates a stroke obtaining screen MN8 displayed on the display screen 512 for obtaining information on strokes. The stroke obtaining screen MN8 displays facial frames WFL and WFR representing two detected facial areas in overlay with the target image DIM similar to the facial area addition screen MN7. The stroke obtaining screen MN8 also shows a prompt message PT8 that prompts the user to enclose the location of undetected facial area with the stylus 20, a “DONE” button BD8, and an “UNDO” button BU8.

In the example of FIG. 9B, the user has drawn a line TSF around the face of the person at the center whose facial areas is not detected among the target images DIM. Thus, when the user operates the “DONE” button BD8 after drawing the line TSF, the drawn line TSF is obtained as a stroke specifying the facial area location. On the other hand, when the user operates the “UNDO” button BU8, the line TSF drawn by the user is deleted and the display returns back to the state in which facial area location is not specified.

In Step S218 of FIG. 8, the processing area detecting unit 152 reexecutes the detection processing on the facial area within the stroke obtained in Step S216. In the facial area the detection processing performed in Step 216, the parameter for the detection processing is changed so as to allow detection of a facial area which is not detected by the facial area detection processing performed in Step S210. Then, due to the change in the parameter for the detection processing, a facial area within the stroke is detected additionally.

After the facial area detection processing in Step S218, the process goes back to Step S212. Then, in Step S212, facial area detection results in Step S210 and Step S218 are displayed on the display screen 512 of the touch screen panel 510 (FIG. 2).

FIG. 9C illustrates a facial area addition screen MN7a displayed in Step S212 after the facial area is detected within the line TSF drawn in Step S218 as in FIG. 9B. In Step S218, the facial area of the person at the center among the target images DIM, which is located within the line TSF drawn in FIG. 9B, is detected. As a result, the facial area addition screen MN7a displays a facial frame WFM representing the facial area of the person at the center, in addition to the two facial frames WFL and WFR, which are already displayed in the facial area addition screen MN7 in FIG. 9A, in overlay with each target image DIM. Also, the prompt message PT7a is changed to notify that three facial areas are detected, including the one additionally detected in Step S218.

Thus, in the second embodiment, a facial area is additionally detected due to the entrance of a graphic image (stroke) for adding a facial area on the target image DIM which is displayed on the display screen 512 of the touch screen panel 512. Therefore, the face modification processing on the facial area, which is not detected by the analysis of the entire target image, may be performed.

In the second embodiment, additional detection of facial areas is implemented (Step S218) by performing the facial area detection processing within the stroke obtained in Step S216. It is also possible to perform additional detection of a facial area as long as the approximate location of the face to be detected can be obtained. For example, the location of the face to be additionally detected may be specified by the location on the display screen 512 at the stylus 20 makes contact. In this case, the additional facial area detection processing may be performed within a given size area around the contact point of the stylus 20.

In addition, in the second embodiment, the facial area detection processing is performed in Step S218. It is also possible to omit the facial area detection processing, and to specify the area within the stroke obtained in Step S216 as the facial area. Thus, the undetected facial area is obtained more reliably, by specifying the area within the stroke as a facial area.

Moreover, in the second embodiment, it is possible to omit the facial area detection processing in Step S210. Even if the facial area detection processing in Step S210 is omitted, a facial area subject to the face modification processing is obtained by repeating the steps from Step S212 to Step S218.

### C. Variations

The present invention is not limited to the embodiments hereinabove and may be reduced to practice in various forms without departing the scope thereof including the following variations, for example.

### C1. Variation 1:

In each of the embodiments hereinabove, the present invention is applied to the face modification processing performed on the target image. The present invention is also applicable to any image processing, as long as the image processing is performed on facial areas within the target image. For example, the present invention can be applied to red-eye reduction processing.

### C2. Variation 2:

In each of the embodiments hereinabove, the user provides an instruction to the multi-function printer 10 by touching the display screen 512 of the touch screen panel 510 (FIG. 2) with the stylus 20 (FIG. 2). It is also possible for the user to provide the instruction to the multi-function printer 10 without using the stylus 20. In general, a touch screen panel is required only to obtain instruction from the user specifying a location on the display screen 512. For example, the touch screen panel 510 may obtain positional information on the display screen 512 specified by the user, by detecting a location where the user's finger touches to the display screen 512. In this way, the multi-function printer 10 is also able to obtain various instructions from the user based on the locating instruction obtained by the touch screen panel 512.

### C3: Variation 3:

In each of the embodiments hereinabove, the present invention is applied to the multi-function printer 10 (FIG. 2). The present invention is also applicable to any device, as long as the device has the touch screen panel 510 and it is an image printing apparatus capable of performing predetermined image processing. For example, the present invention can be applied to printers lacking scanner or copier functions.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image printing apparatus comprising:
a touch screen panel, having a display screen to display an image, configured to acquire a locating instruction from a user for specifying a location on the display screen; and
an image processing unit configured to perform predetermined image processing on a facial area containing a human face within a target image, the target image being targeted for printing by the image printing apparatus,
wherein the image processing unit includes:
a target image display control unit configured to display the target image on the display screen; and
a processing area identifying unit configured to identify the facial area within the target image subject to the predetermined image processing based on the locating instruction, the locating instruction being acquired by the touch screen panel and specifying a location within an area on the display screen where the facial area is present.

2. The image printing apparatus according to claim 1, wherein
the image processing unit has:
a facial area detecting unit configured to detect one or more facial areas within the target image by analyzing the target image; and
a detection result display control unit configured to superimposedly display the target image and one or more facial area locating images on the display screen, the facial area locating images showing location of the facial areas within the target image detected by the facial area detecting unit,
wherein if the location within a display area for one of the facial area location images on the display screen is specified by the locating instruction, the processing area identifying unit identifies a facial area corresponds to the display area containing the location specified by the locating instruction, as the facial area to be subject to the predetermined image processing.

3. The image printing apparatus according to claim 1, wherein
the image processing unit has a location-specified facial area obtaining unit configured to obtain a facial area within the target image based on a location within the target image specified by the locating instruction, and
the processing area identifying unit identifies the facial area obtained by the location-specified facial area obtaining unit as the facial area subject to the predetermined image processing.

4. The image printing apparatus according to claim 3, wherein
the location-specified facial area obtaining unit has a location-specified facial area detecting unit configured to detect one or more facial areas within the target image by analyzing the target image based on the location within the target image specified by the locating instruction.

5. A method of image processing for performing predetermined image processing with the aid of an image printing apparatus including a touch screen panel having a display screen, the method comprising the steps of:
(a) displaying the target image on the display screen targeted for printing by the image printing apparatus;
(b) acquiring a locating instruction from a user for specifying a location on the display screen with the touch screen panel;
(c) identifying a facial area containing a human face within the target image based on the locating instruction, the locating instruction specifying a location within an area on the display screen where the facial area is present; and
(d) performing the predetermined image processing on the facial area identified by the step (c).
